(19) United States
(12) Patent Application Publication
(10) Pub. No.: US 2007/0172069 A1
(43) Pub. Date: Jul. 26, 2007

(54) Domain management method and apparatus

(75) Inventors: Bong-seon Kim, Seongnam-si (KR); Myung-sun Kim, Uiwang-si (KR); Sung-hyu Han, Seoul (KR); Young-sun Yoon, Suwon-si (KR); Sun-nam Lee, Suwon-si (KR); Jae-heung Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/410,033

(22) Filed: Apr. 25, 2006

Related U.S. Application Data
(60) Provisional application No. 60/674,333, filed on Apr. 25, 2005.

(30) Foreign Application Priority Data
Jul. 20, 2005 (KR) 10-2005-0065669

(51) Int. Cl. H04L 9/00

(52) U.S. Cl. 380/278; 380/286; 380/44

(57) ABSTRACT

A method and apparatus of protecting digital content within a domain is provided. if a device registered with a domain withdraws from the domain, a domain key used in the domain before withdrawal of the device is updated to a domain key which cannot be used by the device; and the domain key not exposed to the device is transmitted to a plurality of devices currently registered with the domain so that only the currently registered devices have the most recent domain key. Therefore, devices not registered with the domain and devices which previously registered with the home domain but withdrawn from the home domain can be prevented from using digital content currently shared within the domain. In addition, registered devices that withdraw from the home domain may use digital content legitimately downloaded from the home domain before they withdrew from the domain.

### CROSS-REFERENCE TO RELATED PATENT APPLICATION

This application claims priority from Korean Patent Application No. 10-2005-0065669, filed on Jul. 20, 2005, in the Korean Intellectual Property Office, and U.S. Provisional Application No. 60/674,333, filed on Apr. 25, 2005, in the U.S. Patent & Trademark Office, the disclosures of which are incorporated herein by reference in their entirety.

### BACKGROUND OF THE INVENTION

1. Field of the Invention

Apparatuses and methods,-consistent with the present invention relate to domain management, and more particularly, to protecting digital content in a domain.

2. Description of the Related Art

In recent years, the frequency of digital content transmissions via various communication media such as the Internet, terrestrial waves, cables, and satellites has rapidly increased, and sales and rentals of digital content on recording media with large storage capacities such as compact discs (CDs) and digital versatile discs (DVDs) have also rapidly increased. Accordingly, digital rights management, which is a solution for protecting digital content copyrights, has attracted more public attention than ever. In particular, research has been vigorously conducted to develop methods to allow a legitimate user of a home domain to be freely provided with various content services via devices belonging to the home domain. According to such methods, devices (e.g., digital TVs and PDAs) belonging to the same domain can share their contents with one another.

It is desirable to protect content within a domain by allowing only devices registered with the domain to use the content, preventing devices unregistered with the domain or devices which were once registered with the domain but have withdrawn from the domain from using the content, and allowing the once-registered devices to use content which had been legitimately downloaded from the domain before they withdrew from the domain. However, techniques for protecting content within a domain in this manner have not yet been developed.

### SUMMARY OF THE INVENTION

The present invention provides a domain management apparatus and method which enable only devices currently registered with a domain to use digital content shared within the domain and enable devices which were once registered with the domain but have withdrawn from the domain to use digital content which had been legitimately downloaded from the domain before they withdrew from the domain.

According to an aspect of the present invention, there is provided a domain management method of managing at least one device using a domain key which is a decryption key shared by a plurality of devices registered with a home domain. The domain management method includes: if a device registered with the home domain withdraws from the home domain, updating a first domain key which had been used before the withdrawal of the device to a second domain key which is not exposed to the device; and transmitting the second domain key to the devices registered with the home domain.

The domain management method may also include, if content is received from outside the home domain after the updating: encrypting the content in such a manner that the encrypted content can be decrypted only with the second domain key; and transmitting the encrypted content to a device which requests the content.

The domain management method may also include transmitting the first domain key and the second domain key to a device which registers with the home domain after the updating.

According to another aspect of the present invention, there is provided a computer-readable recording medium storing a computer program for executing the domain management method.

According to another aspect of the present invention, there is provided a domain management apparatus which manages at least one device using a domain key which is a decryption key shared by a plurality of devices registered with a home domain. The domain management apparatus includes: a domain key update unit which, if a device registered with the home domain withdraws from the home domain, updates a domain key which had been used before the withdrawal of the device to a domain key which is not exposed to the device; and a domain key transmission unit which transmits a domain key to a device newly registered with the home domain and, if the domain key update unit updates the domain key, transmits the updated domain key to a plurality of devices registered with the home domain.

### BRIEF DESCRIPTION OF THE DRAWINGS

The above and other aspects of the present invention will become more apparent by describing in detail exemplary embodiments thereof with reference to the attached drawings in which:

FIG. 1 is a diagram illustrating the format of link information according to an exemplary embodiment of the present invention;

FIG. 2 is a diagram illustrating the format of content information according to an exemplary embodiment of the present invention;

FIG. 3 is a flowchart illustrating a domain management method according to an exemplary embodiment of the present invention;

FIG. 4 is a diagram illustrating information flow when a first device is registered with a home domain, according to an exemplary embodiment of the present invention;

FIG. 5 is a diagram illustrating information flow when a second device is registered with the home domain, according to an exemplary embodiment of the present invention;

FIG. 6 is a diagram illustrating a method by which a domain management apparatus according to an exemplary embodiment of the present invention receives first content and provides the first content to the devices registered with the home domain, according to an exemplary embodiment of the present invention;

FIG. 7 is a diagram illustrating information flow when the first device registered with the home domain withdraws from the home domain, according to an exemplary embodiment of the present invention;

FIG. 8 is a diagram illustrating a method in which the domain management apparatus receives second content and provides the same to the second device which is still registered with the home domain, according to an exemplary embodiment of the present invention;

FIG. 9 is a diagram illustrating information flow when a third device is registered with the home domain, according to an exemplary embodiment of the present invention;

FIG. 10 is a diagram illustrating information flow when a fourth device is registered with the home domain, according to an exemplary embodiment of the present invention; and

FIG. 11 is a block diagram of a domain management apparatus according to an exemplary embodiment of the present invention.

### DETAILED DESCRIPTION OF THE INVENTION

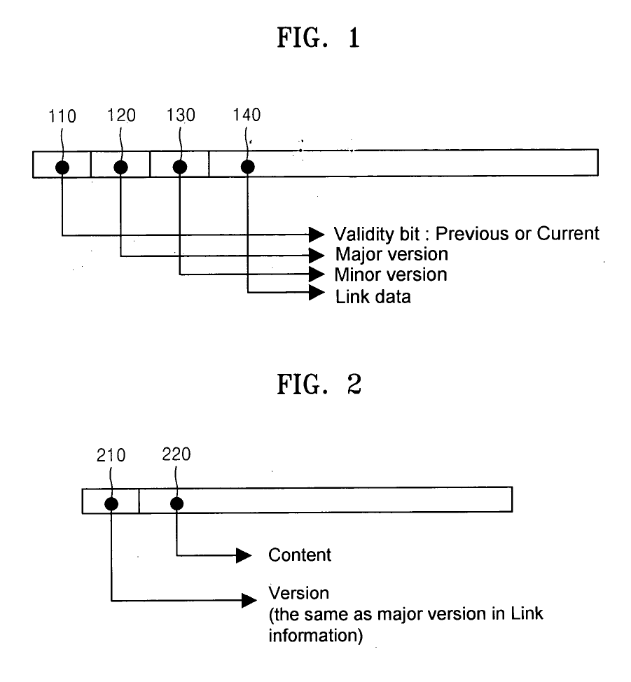

FIG. 1 is a diagram illustrating the format of link information according to an exemplary embodiment of the present invention.

A domain management apparatus according to an exemplary embodiment of the present invention encrypts a domain key, which is a decryption key shared within a home domain, using a public key infrastructure (PKI)-based public key of each of a plurality of devices registered with the home domain, thereby generating link information. Thereafter, the domain management apparatus stores the link information and transmits the link information to the devices registered with the home domain. Referring to FIG. 1, the link information comprises a validity bit field 110, a major version field 120, a minor version field 130, and link data field 140. The validity bit field 110 indicates whether the link information is the most recent link information. It is determined whether the link information is the most recent link information by determining whether a domain key included in the link data 140 is currently in circulation.

The major version field 120 indicates the version of the domain key included in the link data 140. The value of the major version field 120 increases whenever a device withdraws from the home domain. The minor version field 130 also indicates the version of the domain key included in the link data 140. The value of the minor version field 130 increases whenever a device is registered with the home domain. Accordingly, the domain management apparatus according to an exemplary embodiment of the present invention can determine which of a plurality of pieces of link information having the same major version field values is the most recent link information with reference to the minor version field values of the plurality of pieces of link information.

The link data 140 comprises a domain key which is encrypted with each of the public keys of the devices currently registered with the home domain. Therefore, the devices currently registered with the home domain can restore a domain key by receiving the link data 140 and decrypting the link data 140 with their respective private keys. Whenever the value of the major version field 120 or the minor version field 130 changes, i.e., whenever a device other than the devices currently registered with the home domain is registered with the home domain or one of the devices currently registered with the home domain withdraws from the home domain, the domain management apparatus according to an exemplary embodiment of the present invention updates all link information in accordance with the change in the major version field 120 or the minor version field 130 and then transmits the updated link information to each of the devices currently registered with the home domain, thereby keeping up-to-date device information regarding the devices currently registered with the home domain and domain key information.

FIG. 2 is a diagram illustrating the format of content information according to an exemplary embodiment of the present invention. Referring to FIG. 2, the content information comprises a version field 210 and a content field 220. The version field 210, like the major version field 120 of FIG. 1, indicates the version of a domain key. When the domain management apparatus according to an exemplary embodiment of the present invention receives digital content from an external source, the version of a home domain key in circulation when the digital content is received is recorded in the version field 210. The content field 220 comprises encrypted data which is obtained by encrypting the digital content and can be decrypted with the home domain key. Therefore, a legitimate device can restore the digital content by receiving the content information and decrypting the encrypted data included in the content field 220 of the content information with the home domain key.

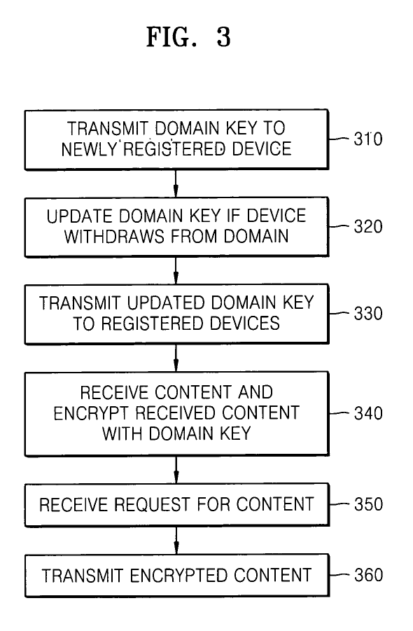

FIG. 3 is a flowchart illustrating a domain management method according to an exemplary embodiment of the present invention. Referring to FIG. 3, in operation 310, when a device is registered with a home domain, a domain management apparatus according to an exemplary embodiment of the present invention generates link information by encrypting a current domain key with a public key of the newly registered device, and transmits the link information to the newly registered device. In operation 310, if there are domain keys (hereinafter referred to as previous domain keys) whose version is lower than the version of the current domain key, the domain management apparatus may also transmit the previous domain keys to the newly registered device together with the current domain key, thereby enabling the newly registered device to use all digital content stored in the domain management apparatus.

If one of a plurality of devices registered with the home domain withdraws from the home domain, the domain management apparatus updates the current domain key in operation 320, and transmits the updated domain key to the remaining registered devices in operation 330, thereby keeping the current domain key up-to-date throughout the registered devices. Thereafter, if the domain management apparatus receives digital content from an external source, it encrypts the digital content with a domain key which is in circulation when the digital content is received in operation 340. If a registered device issues a request for the digital content to the domain management apparatus in operation 350, the domain management apparatus transmits the encrypted digital content to the registered device in operation 360. Then, the registered device can decrypt the encrypted digital content with the domain key held by the registered device.

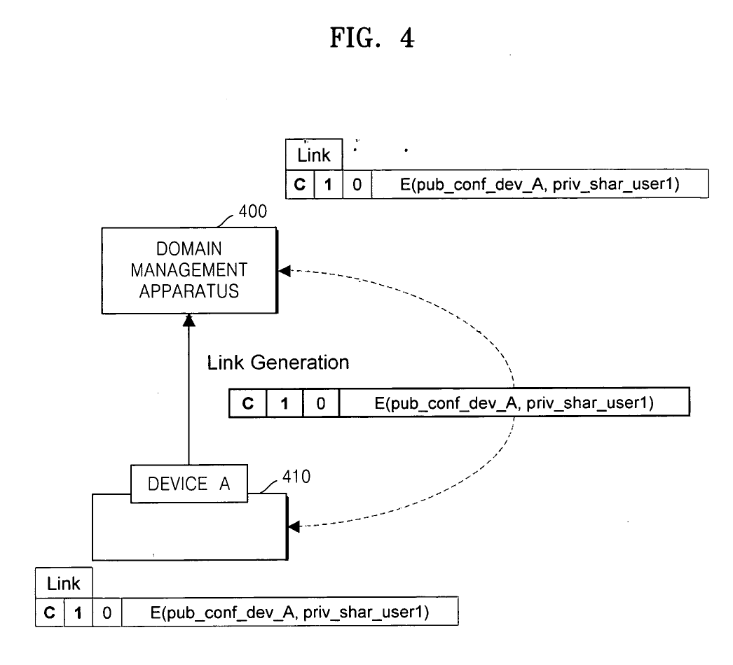

FIG. 4 is a diagram illustrating information flow when device A (410) is registered with a home domain, according to an exemplary embodiment of the present invention. Referring to FIG. 4, device A (410) issues a request for registration of device A (410) in the home domain to a domain management apparatus 400 by transmitting a public key pub_conf_dev_A of device A (410) to the domain management apparatus (400). Then, the domain management apparatus 400 encrypts a domain key priv_shar_user1 with the public key pub_conf_dev_A and generates link information for device A (410) which comprises a validity bit field in which the character “C” is recorded indicating that the encrypted domain key priv_shar_user1 is the most recent domain key, and a major version field in which a value of 1 is recorded as version information of the encrypted domain key priv_shar_user1. The domain management apparatus 400 transmits the link information to device A (410), and device A (410) receives and stores the link information. Accordingly, the encrypted domain key priv_shar_user1 can only be decrypted by device A (410) using a private key of device A (410).

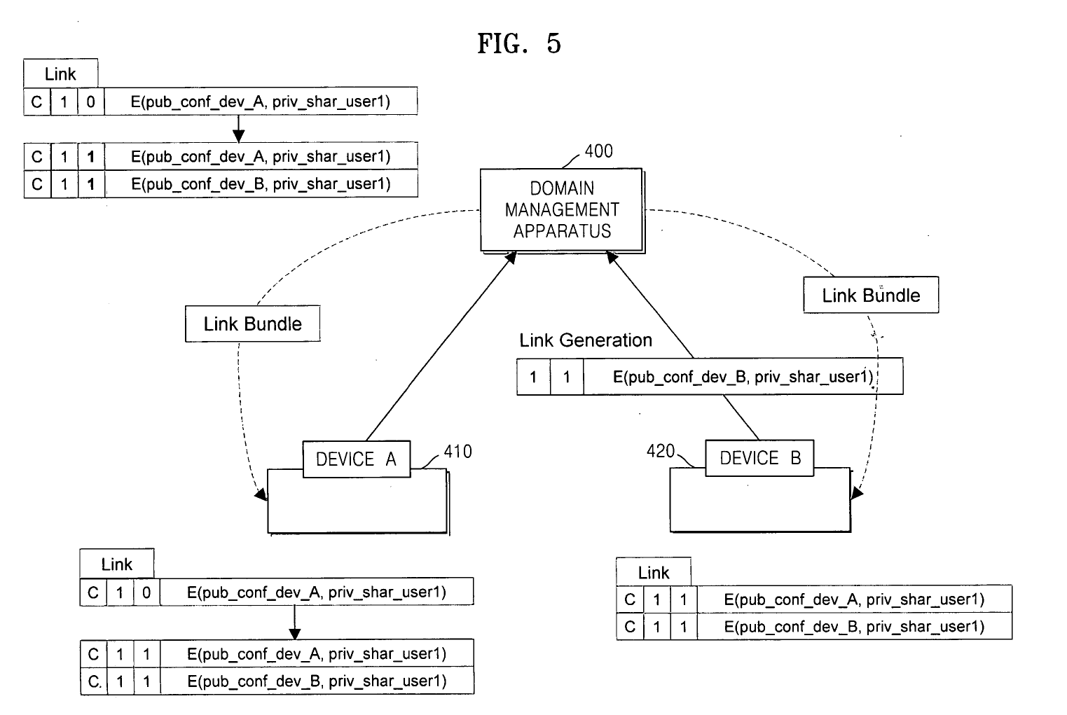

FIG. 5 is a diagram illustrating information flow when device B (420) is registered with the home domain after device A (410) has registered with the home domain, according to an exemplary embodiment of the present invention. Referring to FIG. 5, device B (420) issues a request for registration of device B (420) with the home domain to the domain management apparatus 400 by transmitting a public key pub_conf_dev_B of device B (420) to the domain management apparatus 400. Then, the domain management apparatus 400 generates link information for device B (420). Thereafter, the domain management apparatus 400 adds the link information for device B (420) to the link information for device A (410) and simultaneously increases the minor version field values of the link information for device A (410) and the link information for device B (420) by 1. In short, according to the current embodiment of the present invention, when a device is registered with a domain, a domain key and a major version field value of link information do not change; only a minor version field value of the link information increases. Thereafter, the domain management apparatus 400 transmits the link information for device A (410) and the link information for device B (420) to all registered devices, i.e., device A (410) and device B (420). Therefore, device B (420) can also decrypt the encrypted domain key priv_shar_user1 with a private key of device B (420).

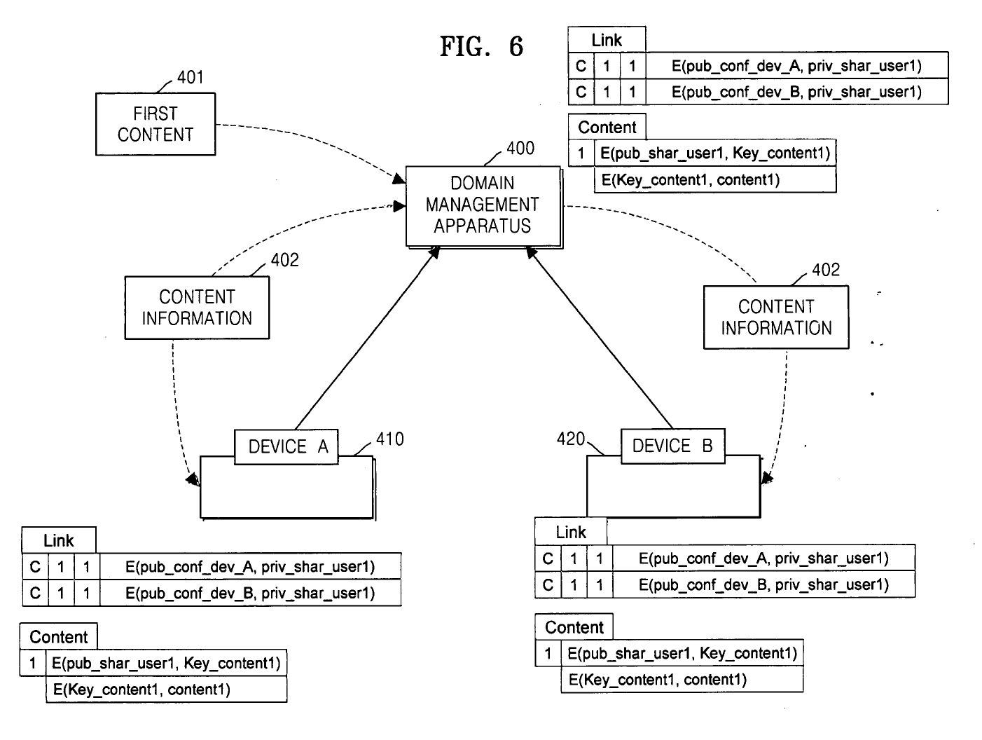

FIG. 6 is a diagram illustrating a method by which the domain management apparatus 400 receives first content 401 and provides the first content 401 to all registered devices, i.e., device A (410) and device B (420), according to an exemplary embodiment of the present invention. Referring to FIG. 6, the domain management apparatus 400 receives the first content 401 from an external source, encrypts the first content 401 with a content key Key_content1, which is a symmetric key for the first content 401, and encrypts the content key Key_content 1 with an encryption key pub_shar_user1, thereby generating content information 402. Here, the encryption key pub_shar_user1 can only be decrypted using a home domain key in circulation when the first content 401 is received, i.e., the domain key priv_shar_user1. As described above, the version of the content information 402 is the same as the version of the domain key priv_shar_user1, and is thus 1.

Thereafter, the domain management apparatus 400 transmits the content information 402 to device A (410) and device B (420) upon the request of device A (410) and device B (420). Accordingly, all registered devices, i.e., device A (410) and device B (420), can restore the first content 401 by decrypting the encrypted domain key priv_shar_user1 included in the link information for device A (410) and the link information for device B (420) with the private keys of device A (410) and device B (420), respectively, decrypting the encrypted content key pub_shar_user1 with the decrypted domain key priv_shar_user1, and decrypting the encrypted first content 401 with the decrypted content key pub_shar_user1.

The content key pub_shar_user1 may be a PKI-based public key, and the domain key priv_shar_user1 may be a PKI-based private key corresponding to the content key pub_shar_user1. However, the present invention is not limited thereto. In other words, the present invention can be applied to the case where the content key pub_shar_user1 is identical to the domain key priv_shar_user1, i.e., the case where the domain key priv_shar_user1 is a symmetric key.

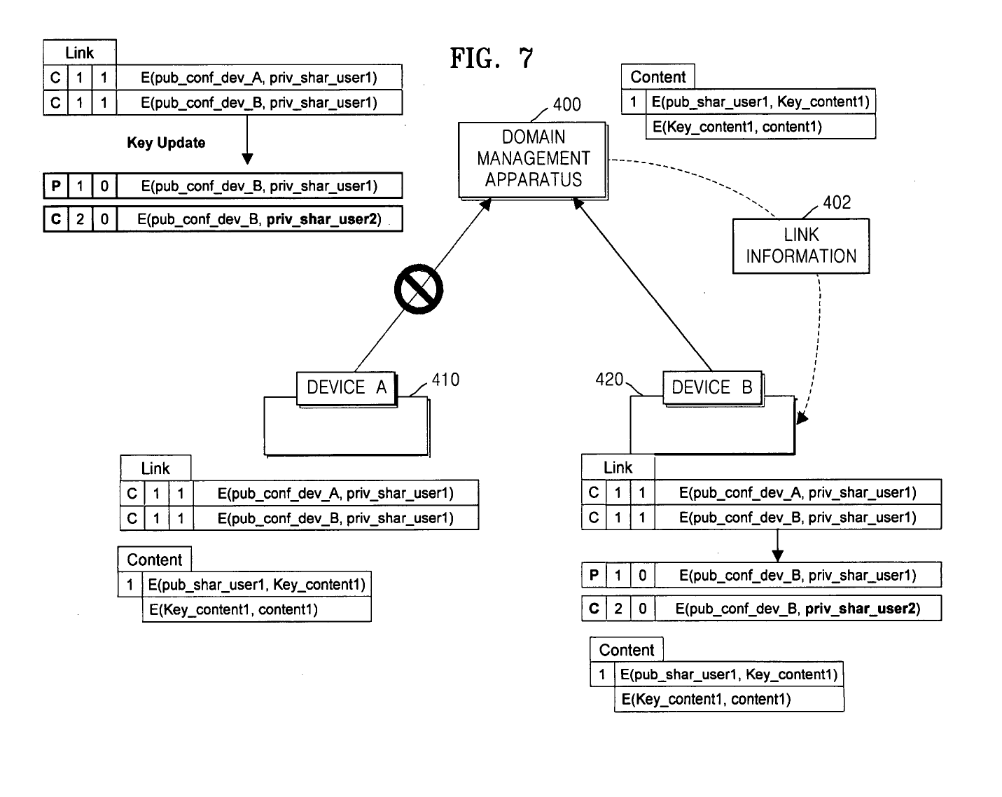

FIG. 7 is a diagram illustrating information flow when device A (410), which is registered with the home domain as illustrated in FIG. 6, withdraws from the home domain, according to an exemplary embodiment of the present invention. Referring to FIG. 7, when device A (410) withdraws from the home domain, the domain management apparatus 400 deletes the link information for device A (410) and updates the domain key priv_shar_user1, thereby obtaining a domain key priv_shar_user2.

The domain management apparatus 400 replaces the character “C” recorded in the validity bit field of the link information for device B (420), which is still registered with the home domain, with the character “P” to indicate that the link information for device B (420) is no longer the most recent link information, and encrypts the domain key priv_shar_user2 with the public key pub_conf_dev_B of device B (420), thereby generating new link information for device B (420). Accordingly, the character “C” is recorded in a validity bit field of the new link information for device B (420). Since the domain key priv_shar_user1 is updated to the domain key priv_shar_user2, the major version field value of the new link information for device B is 2. In short, according to the current exemplary embodiment of the present invention, whenever a registered device withdraws from a domain, the major version field value of link information increases by 1, while the minor version value of the link information is reset to 0.

The domain management apparatus 400 transmits the new link information for device B (420) to device B (420), and device B (420) replaces the old link information for device B (420) with the new link information for device B (420).

As a result, device A (410) can still use digital content legitimately downloaded from the home domain, i.e., the first content 401, even though it has withdrawn from the home domain, because the domain key priv_shar_user1, which can decrypt the first content 401, is encrypted with the public key priv_shar_user1 of device A (410). However, device A (410) cannot use digital content newly received after device A (410) has withdrawn from the home domain because the other digital content is encrypted in such a manner that it can only be decrypted with the domain key priv_shar_user2 having a major version field value of 2. On the other hand, device B (420) can freely use not only the first content 401 but also other digital content encrypted with the domain key priv_shar_user2 because device B (420) holds both the old link information for device B (420) including the encrypted domain key priv_shar_user1 and the new link information for device B (420) including the encrypted domain key priv_shar_user2.

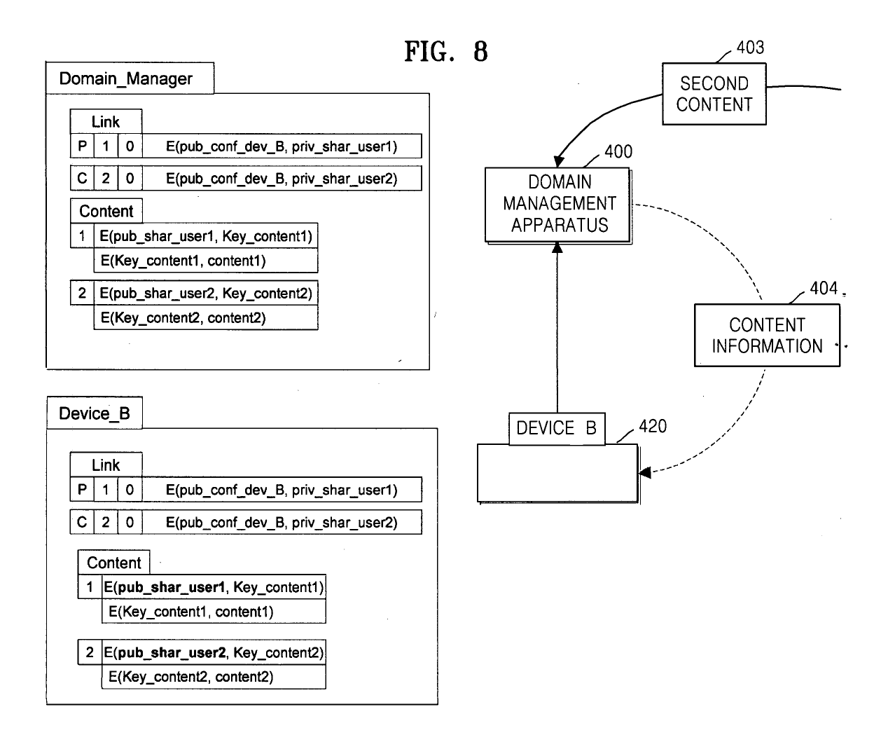

FIG. 8 is a diagram illustrating a method in which the domain management apparatus 400 receives second content 403 and provides the second content 403 to device B (420) under the circumstances illustrated in FIG. 7, according to an exemplary embodiment of the present invention. Referring to FIG. 8, the domain management apparatus 400 receives the second content 403, encrypts the second content 403 with a content key Key_content2, which is a symmetric key for the second content 403, and encrypts the content key Key_content2 with an encryption key pub_shar_user2 so that the encrypted content key Key_content2 can only be decrypted using a domain key in circulation when the second content 403 is received, i.e., the domain key priv_shar_user2, thereby generating content information 404. The version field value of the content information 404 is the same as the major version field value of the link information, which is the most recent link information when the second content 403 is received, and is thus 2. The domain management apparatus 400 transmits the content information 404 to device B (420) upon the request of device B (420). Then, device B (420) can use not only the first content 401 but also the second content 403 by using the domain key priv_shar_user2 included in the most recent link information.

Here, device B (420) can determine which of the domain keys priv_shar_user1 and priv_shar_user2 is needed to use content information with reference to the version field of the content information. For example, in order to use the encrypted second content 403 which has a version field value of 2, link information having a major version field value of 2 is searched for, and the encrypted domain key priv_shar_user2 included in the discovered link information is decrypted with the private key of device B (420). Thereafter, the encrypted content key Key_content2 is decrypted with the decrypted domain key priv_shar_user2, and then, the encrypted second content 403 is decrypted with the decrypted content key Key_content2.

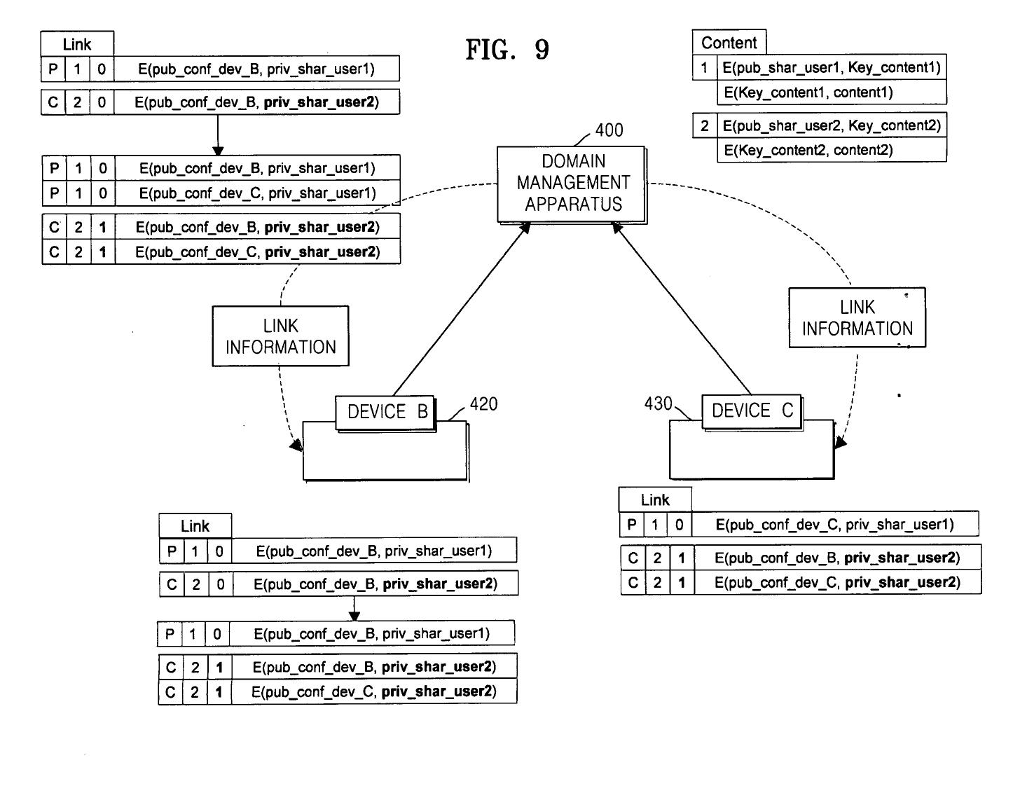

FIG. 9 is a diagram illustrating information flow when device C (430) is registered with the home domain under the circumstances illustrated in FIG. 8, according to an exemplary embodiment of the present invention. Referring to FIG. 9, device C (420) issues a request for registration of device C (420) in the home domain to the domain management apparatus 400. Then, the domain management apparatus 400 updates all link information stored in the domain management apparatus 400 and transmits the updated link information to device B (420) and device C (430).

At this time, the domain management apparatus 400 generates the link information by encrypting not only a current domain key, i.e., the domain key priv_shar_user2, but also a previous domain key, i.e., the domain key priv_shar_user1, with a public key of device C (430). Accordingly, the link information has a major version field value of 1 in accordance with the version of the domain key priv shar_user1, and the character “P” is recorded in a validity bit field of the link information because the domain key priv_shar_user1 is not the current domain key. Thereafter, the domain management apparatus (400) transmits the link information to device C (430). Therefore, device C (430) can use not only the first and second contents 401 and 403 but also other content by issuing a request to the domain management apparatus 400.

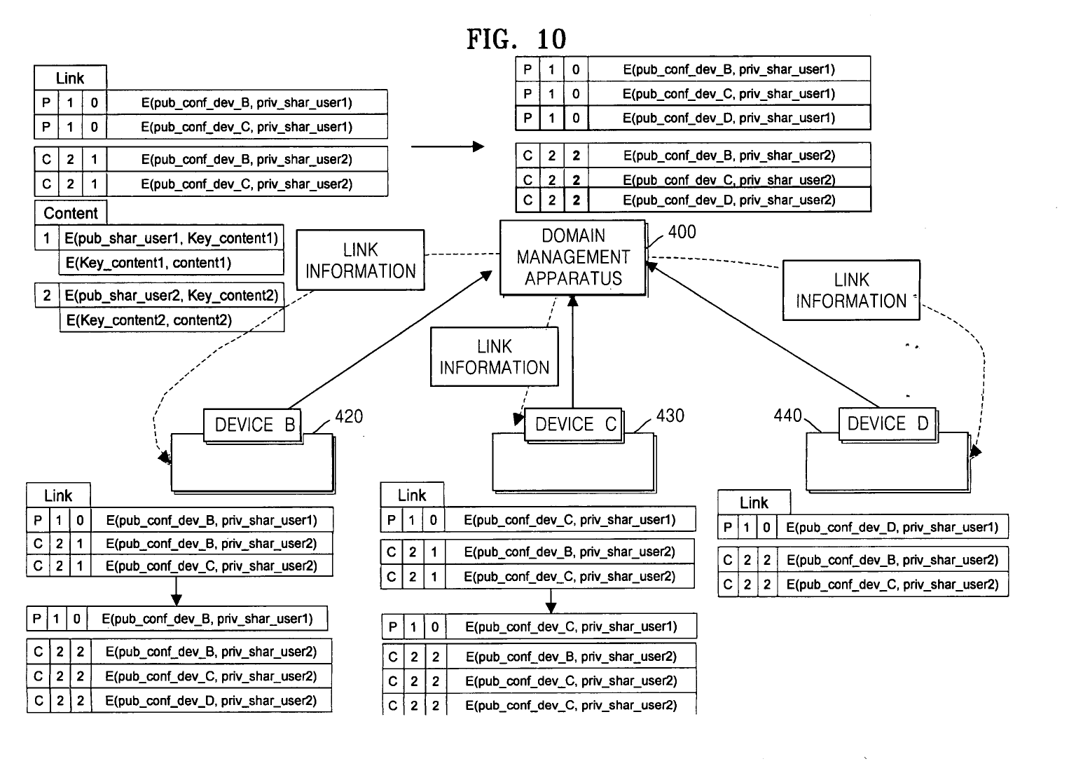

FIG. 10 is a diagram illustrating information flow when device D (430) is registered with the home domain under the circumstances illustrated in FIG. 9, according to an exemplary embodiment of the present invention. Referring to FIG. 10, device D (430) issues a request for registration of device D (430) to the home domain, and the domain management apparatus 400 updates all link information as described above with reference to FIG. 9. Therefore, the minor version value of link information containing the most recent domain key changes from 1 to 2 when device D (440) is registered with the home domain. Since none of the devices registered with the home domain prior to the registration of device D (440) with the home domain have withdrawn from the home domain, the major version field value of the link information, i.e., the most recent domain key, is not updated. Therefore, device D (440) can use not only the first and second contents 401 and 403 but also other content.

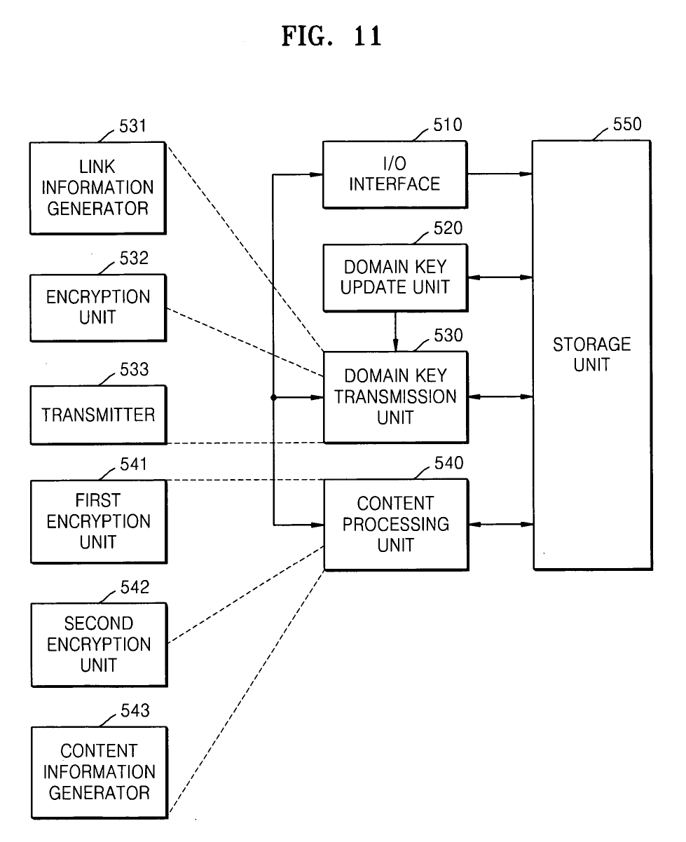

FIG. 11 is a block diagram of a domain management apparatus 400 according to an exemplary embodiment of the present invention. Referring to FIG. 11, the domain management apparatus 400 includes an I/O interface 510, a domain key update unit 520, a domain key transmission unit 530, a content processing unit 540, and a storage unit 550. The domain key transmission unit 530 includes a link information generator 531, an encryption unit 532, and a transmitter 533. The content processing unit 540 includes a first encryption unit 541 and a second encryption unit 542.

The I/O interface 510 enables the domain management apparatus 400 to transmit/receive data to/from a device outside or inside a home domain. The storage unit 550 stores link information, domain keys, and content.

The domain key update unit 520 generates an updated domain key when a registered device withdraws from the home domain. The domain key update unit 520 transmits the updated domain key to the domain key transmission unit 530.

The transmitter 533 of the domain key transmission unit 530 transmits link information including a domain key to a newly registered device. When the domain key is updated, the transmitter 533 of the domain key transmission unit 530 transmits link information including the updated domain key to all registered devices. If a domain key needs to be transmitted to a newly registered device and the domain key has been updated at least once, the transmitter 533 of the domain key transmission unit 530 transmits the domain key to the newly registered device together with all previous domain keys so that the newly registered device can use all content available in the home domain.

The encryption unit 532 encrypts a domain key with a public key of a registered device. The link information generation unit 531 generates link information by adding a validity bit field, a major version field, and a minor version field to an encrypted domain key. The transmitter 533 transmits link information to all registered devices, thereby enabling the registered devices to obtain a domain key.

The content processing unit 540 encrypts digital content in such a manner that the encrypted digital content can only be decrypted with a domain key in circulation when the digital content has been received. Thereafter, the content processing unit 540 transmits the encrypted digital content to a device which has requested the digital content. In detail, the first encryption unit 541 encrypts digital content with a content key which is a symmetric key for the digital content, and the second encryption unit 542 generates content information by encrypting the content key in such a manner that the encrypted digital content can only be decrypted with the domain key. in circulation when the digital content was received. Then, the content information transmitter 543 transmits the content information to the device which has requested the digital content.

The domain key transmission unit 530 transmits a domain key to a registered device together with update version information of the domain key, and the content processing unit 540 transmits encrypted digital content to a registered device together with update version information of a domain key needed to decrypt the encrypted digital content, thereby enabling a registered device to easily search for an appropriate domain key for certain digital content even when receiving two or more digital contents at the same time.

The present invention can be realized as computer-readable code written on a computer-readable recording medium. The computer-readable recording medium may be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission through the Internet).

According to the present invention, devices which have not been registered with a home domain can be prevented from using digital content shared within the home domain by sharing a domain key only between devices currently registered with the home domain, and devices which were previously registered with the home domain but have withdrawn from the home domain can use only digital content which had been legitimately downloaded to the home domain before they withdrew from the home domain. Therefore, it is possible to efficiently manage a domain in such a manner that digital content can be shared only between currently registered devices.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A domain management method comprising:
if a device of a plurality of devices registered with a domain withdraws from the domain, updating a first domain key used before a withdrawal of the device to a second domain key which is not exposed to the device; and
transmitting the second domain key to the plurality of devices registered with the domain.

2. The domain management method of claim 1 further comprising, if content is received from outside the domain after the updating:
encrypting the content so that the encrypted content can be decrypted only with the second domain key; and
transmitting the encrypted content to a device which requests the content.

3. The domain management method of claim 1 further comprising transmitting the first domain key and the second domain key to a device which registers with the domain after the updating.

4. The domain management method of claim 3, wherein the transmitting the first domain key and the second domain key to the newly registered device comprises:
encrypting the first domain key and the second domain key with a public key of the device registered with the domain after the updating; and
transmitting the encrypted first domain key and the encrypted second domain key to the newly registered device.

5. The domain management method of claim 2, wherein the encrypting comprises encrypting the content with a content key, wherein the encrypted content key can only be decrypted by one of the first and second domain keys that is in circulation when the content is received.

6. The domain management method of claim 1, wherein the first domain key and the second domain key are symmetric keys.

7. The domain management method of claim 1, wherein the first domain key and the second domain key are public key infrastructure (PKI)-based private keys or PKI-based public keys.

8. A domain management apparatus comprising:
a domain key update unit which, if a device of a plurality of devices registered with a domain withdraws from the domain, updates a first domain key used before the withdrawal of the device to a second domain key which is not exposed to the device; and
a domain key transmission unit which, if the domain key update unit updates the first domain key to the second domain key, transmits the second domain key to the plurality of devices registered with the domain.

9. The domain management apparatus of claim 8, wherein the domain management transmission unit transmits the first domain key and the second domain key to a device which newly registers with the domain after the first domain after the first domain key is updated to the second domain key.

10. The domain management apparatus of claim 8 further comprising a content processing unit which, if content is received from outside the domain after the updating, encrypts the content so that the encrypted content can only be decrypted with the second domain key and transmits the encrypted content to a device which requests the content.

11. The domain management apparatus of claim 9, wherein the domain key transmission unit comprises:
an encryption unit which encrypts the first and second domain keys with a public key of the newly registered device; and
a transmitter which transmits the encrypted first and second domain keys to the newly registered device.

12. The domain management apparatus of claim 10, wherein the domain key transmission unit transmits the first and second domain keys to the newly registered device together with update version information of the the first and second domain keys, and the content processing unit transmits the encrypted content to the newly registered device together with the update version information.

13. The domain management apparatus of claim 9, wherein the domain key transmission unit further transmits all previous domain keys to the newly registered device.

14. The domain management apparatus of claim 10, wherein the content processing unit comprises:
a first encryption unit which encrypts the content with a content key; and
a second encryption unit which encrypts a content key so that the encrypted content key can only be decrypted with one of the first and second domain keys that is in circulation when the content is received.

15. The domain management apparatus of claim 8, wherein the first and second domain keys are symmetric keys.

16. The domain management apparatus of claim 8, wherein the first and second domain keys are public key infrastructure (PKI)-based keys.

17. A computer-readable recording medium storing a computer program for executing the domain management method, the method comprising:
if a device of a plurality of devices registered with a domain withdraws from the domain, updating a first domain key used before a withdrawal of the device to a second domain key which is not exposed to the device; and
transmitting the second domain key to the plurality of devices registered with the domain.

18. A method of registering a device with a domain comprising:
issuing a request for registration of the device with the domain to a domain management apparatus; and
receiving a current domain key and all domain keys of the domain which are encrypted with a public key of the device.

19. The method of claim 18 further comprising transmitting the public key of the device to the domain management apparatus.
